(19) United States
(12) Patent Application Publication
(10) Pub. No.: US 2025/0298241 A1
(43) Pub. Date: Sep. 25, 2025

(54) DISPLAY SYSTEM AND DISPLAY DEVICE

(71) Applicants: Beijing BOE Display Technology Co., Ltd., Beijing (CN); BOE Technology Group Co., Ltd., Beijing (CN)

(72) Inventor: Weili ZHAO, Beijing (CN)

(21) Appl. No.: 18/861,011

(22) PCT Filed: Apr. 28, 2023
(86) PCT No.: PCT/CN2023/091888

§ 371 Date: Oct. 28, 2024

(30) Foreign Application Priority Data
Jun. 29, 2022 (CN) 202210759281.3

(51) Int. Cl. G02B 27/01; G02B 30/25

(52) U.S. Cl. CPC G02B 27/0101; G02B 30/25

(57) ABSTRACT

A display system includes a display module configured to emit light, where a linear polarizer is attached to the display module and configured to generate linearly polarized light. In a light path from the display module to an eye, the display system further includes a first switchable quarter wave plate, a first lens, a half mirror, a second switchable quarter wave plate, and a reflective polarizer. The first quarter wave plate is driven at a first voltage and the second quarter wave plate is driven at a second voltage, so that the display system generates an image at a first depth of field; the first quarter wave plate is driven at the first voltage and the second quarter wave plate is driven at a third voltage, so that the display system generates an image at a second depth of field different from the first depth of field.

### CROSS-REFERENCE TO RELATED APPLICATION

The present disclosure is a US national phase of PCT application No. PCT/CN2023/091888 filed on Apr. 28, 2023, which claims priority to Chinese patent application No. 2022107592813 filed on Jun. 29 2022, the entire contents of which are incorporated herein by reference.

### TECHNICAL FIELD

The present application relates to the field of optical imaging technologies, and in particular, to a display system and a display device.

### BACKGROUND

At present, virtual reality (VR) devices on the market are usually conventional binocular parallax 3D displays, and left and right eyes respectively see left and right eye images at a certain depth of field, generating stereo images in the brain.

### SUMMARY

An objective of examples of the present application is to provide a display system and a display device, which can realize a monocular multi-depth-of-field VR display.

In an aspect of the examples of the present application, there is provided a display system. The display system includes a display module configured to emit light, where a linear polarizer is attached to the display module and configured to generate linearly polarized light. In a light path from the display module to an eye, the display system further includes a first switchable quarter wave plate, a first lens, a half mirror, a second switchable quarter wave plate, and a reflective polarizer, where both the first quarter wave plate and the second quarter wave plate have electrodes. The first quarter wave plate is driven at a first voltage and the second quarter wave plate is driven at a second voltage, so that the display system generates an image at a first depth of field; the first quarter wave plate is driven at the first voltage and the second quarter wave plate is driven at a third voltage, so that the display system generates an image at a second depth of field, where the first depth of field is different from the second depth of field.

In another aspect of the examples of the present application, there is provided a display device. The display device includes the display system as described above.

In the display system and the display device according to one or more examples of the present application, by using the switchable wave plates and applying the voltages to the wave plates, the wave plates can switch among several optical states at a relatively high frequency and cooperate with other optical devices, so that a plurality of different focal distances and virtual image distances can be generated. In collaboration with 2D image sources of the display module display different information at a plurality of moments, in a manner of time division multiplexing, images with a plurality of different virtual image distances can be seen, so as to realize a monocular multi-depth-of-field VR display.

### BRIEF DESCRIPTION OF DRAWINGS

The accompanying drawings, which are incorporated in and constitute a part of this specification, illustrate examples consistent with the present application and, together with the description, serve to explain the principle of the present application.

FIG. 1 is a schematic diagram showing a light path of a display system having a first light path according to a first example of the present application.

FIG. 2 is a schematic diagram showing a light path of the display system having a second light path according to the first example of the present application.

FIG. 3 is a schematic diagram showing a light path of a display system having a first light path according to a second example of the present application.

FIG. 4 is a schematic diagram showing a light path of the display system having a second light path according to the second example of the present application.

FIG. 5 is a schematic diagram showing a light path of the display system having a third light path according to the second example of the present application.

FIG. 6 is a schematic diagram showing a light path of the display system having a fourth light path according to the second example of the present application.

FIG. 7 is a schematic diagram showing light paths of a liquid crystal half wave plate before and after being powered on according to an example of the present application.

FIG. 8 is a schematic diagram showing a cross section of ring electrodes of a second liquid crystal quarter wave plate according to an example of the present application.

FIG. 9 is a schematic diagram showing light paths of a second liquid crystal quarter wave plate applied with different voltages according to an example of the present application.

### DETAILED DESCRIPTION

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present application. Rather, they are merely examples of apparatuses consistent with some aspects of the present application as detailed in the appended claims.

The terms used in the examples of the present application are for the purpose of describing particular embodiments only, and are not intended to limit the present application. Unless otherwise defined, technical or scientific terms used in the examples of the present application should have ordinary meaning as understood by one of ordinary skill in the art to which the present application belongs. “First”, “second” and similar words used in the specification and claims of the present application do not represent any order, quantity or importance, but are used only to distinguish different components. Likewise, similar words such as “one”, “a” or “an” do not represent a quantity limit, but represent that there is at least one. “Plurality”, “multiple” or “several” means two or more. Unless otherwise indicated, similar words such as “front”, “rear”, “lower” and/or “upper” are only for convenience of description, and are not limited to one position or one spatial orientation. Similar words such as “including” or “comprising” mean that an element or an item appearing before “including” or “comprising” covers elements or items and their equivalents listed after “including” or “comprising”, without excluding other elements or items. Similar words such as “connect” or “connected with each other” are not limited to physical or mechanical connections, and may include electrical connections, whether direct or indirect. Terms determined by “a/an”, “the” and “said” in their singular forms in the specification and the appended claims of the present application are also intended to include plural forms unless clearly indicated otherwise in the context. It should also be understood that the term “and/or” as used herein refers to and includes any or all possible combinations of one or more associated listed items.

### First Example

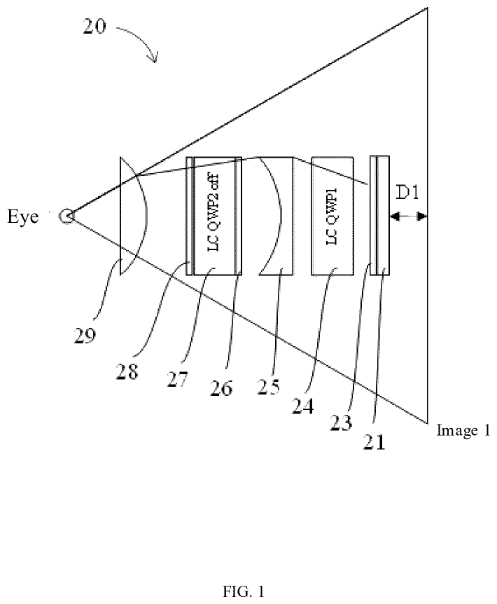

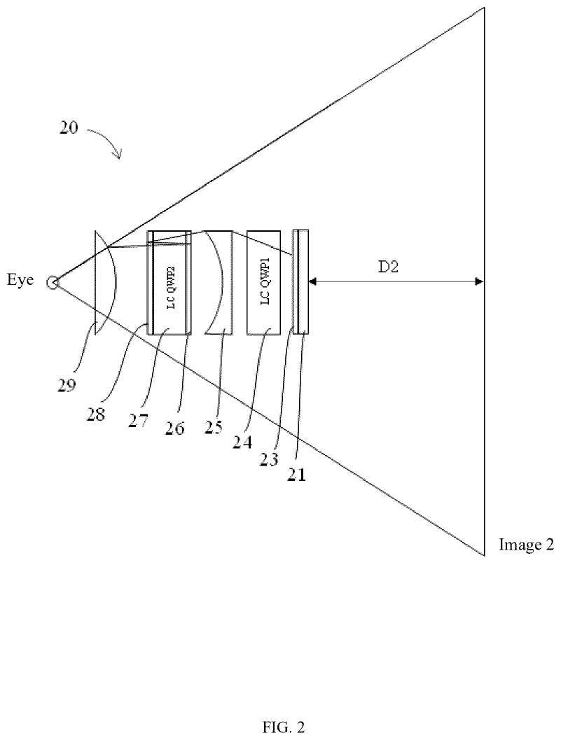

FIG. 1 is a schematic diagram showing a light path of a display system 20 having a first light path according to a first example of the present application. FIG. 2 is a schematic diagram showing a light path of the display system 20 having a second light path according to the first example of the present application. As shown in FIG. 1 and FIG. 2, the display system 20 according to the first example of the present application includes a display module 21 configured to emit light, and a linear polarizer (L-pol) 23 is attached to the display module 21 and may be configured to generate linearly polarized light. In a light path from the display module 21 to an eye side, the display system 20 further includes a first switchable quarter wave plate (QWP) (referred to as QWP1), a first lens 25, a half mirror 26, a second switchable quarter wave plate (QWP2) 27, and a reflective polarizer (ReP) 28.

In some examples, the first switchable quarter wave plate includes a first liquid crystal (LC) quarter wave plate 24; and/or the second switchable quarter wave plate includes a second liquid crystal quarter wave plate 27. Of course, the first quarter wave plate and the second quarter wave plate in the examples of the present application are not limited to using the form of a liquid crystal wave plate. In other examples, the first switchable quarter wave plate and the second switchable quarter wave plate in the examples of the present application may be implemented in other forms that can change an optical state of a wave plate. An example in which the first switchable quarter wave plate is the first liquid crystal quarter wave plate 24 and the second switchable quarter wave plate is the second liquid crystal quarter wave plate 27 will be taken below for illustrative description.

In the display system 20 according to the examples of the present application, by combining the first liquid crystal quarter wave plate 24 on the basis that the linear polarizer 23 is attached to the display module 21, the first liquid crystal quarter wave plate 24 and the second liquid crystal quarter wave plate 27 are liquid crystal wave plates with the same design scheme, and therefore, there is no problem of wavelength dispersion matching, greatly improving the initiative of design.

Both the first liquid crystal quarter wave plate 24 and the second liquid crystal quarter wave plate 27 in the examples of the present application have electrodes and a liquid crystal layer located between the electrodes. The first liquid crystal quarter wave plate 24 may have different optical states under the driving of different voltages, and the second liquid crystal quarter wave plate 27 may also have different optical states under the driving of different voltages.

In some examples, the first liquid crystal quarter wave plate 24 is driven at a first voltage and the second liquid crystal quarter wave plate 27 is driven at a second voltage, so that the display system generates an image at a first depth of field, and the first liquid crystal quarter wave plate 24 is driven at the first voltage and the second liquid crystal quarter wave plate 27 is driven at a third voltage, so that the display system 20 generates an image at a second depth of field, where the first depth of field is different from the second depth of field. Therefore, through the voltage applied to the electrodes of the first liquid crystal quarter wave plate 24 and the voltage applied to the electrodes of the second liquid crystal quarter wave plate 27, the display system 20 in the examples of the present application can generate the image at the first depth of field and the image at the second depth of field. For example, the first voltage and the third voltage may be low voltages, and the second voltage may be a high voltage. The first voltage may be equal to the third voltage, for example, both are equal to 0.

An optical axis of the first liquid crystal quarter wave plate 24 and an optical axis of the second liquid crystal quarter wave plate 27 are orthogonal to each other. An angle between each of the optical axis of the first liquid crystal quarter wave plate 24 and the optical axis of the second liquid crystal quarter wave plate 27 and an optical axis of the linear polarizer 23 is 45 degrees. An optical axis of the reflective polarizer 28 and the optical axis of the linear polarizer 23 are orthogonal to each other. For example, if the polarized linear polarizer 23 is used as a 0° reference angle, the optical axis of one of the first liquid crystal quarter wave plate 24 and the second liquid crystal quarter wave plate 27 that cooperate with the linear polarizer 23 to generate circularly polarized light is +45°, and the optical axis of another one of the first liquid crystal quarter wave plate 24 and the second liquid crystal quarter wave plate 27 that cooperate with the linear polarizer 23 to generate circularly polarized light is −45°; the optical axis of the reflective polarizer 28 is 90°. The half mirror 26 is a light splitter that transmits half of any polarized light and reflects half of the any polarized light. The half mirror 26 is without an optical axis, so that an amount of light transmission and reflection can be better balanced.

In some examples, the first liquid crystal quarter wave plate 24 and the second liquid crystal quarter wave plate 27 may include, for example, a planar first electrode, a planar second electrode, and a liquid crystal layer located between the planar first electrode and the planar second electrode. Through the voltages applied to their respective planar first electrodes and planar second electrodes, an arrangement state of liquid crystal molecules in their respective liquid crystal layers can be changed, so that the first liquid crystal quarter wave plate 24 and the second liquid crystal quarter wave plate 27 can respectively have different optical states.

Both the first liquid crystal quarter wave plate 24 and the second liquid crystal quarter wave plate 27 have a first optical state and a second optical state. The first optical state may include, for example, a quarter wave plate (QWP) state, and the second optical state may include, for example, an off state. When the second liquid crystal quarter wave plate is in the off state, light passing through the second liquid crystal quarter wave plate does not undergo any change.

When no voltage is applied to the electrodes of the first liquid crystal quarter wave plate 24 and/or the second liquid crystal quarter wave plate 27, the first liquid crystal quarter wave plate 24 and/or the second liquid crystal quarter wave plate 27 is/are in a quarter wave plate state. When a voltage is applied to the electrodes of the first liquid crystal quarter wave plate 24 and/or the second liquid crystal quarter wave plate 27, the first liquid crystal quarter wave plate 24 and/or the second liquid crystal quarter wave plate 27 is/are in an off state.

In some examples, the display system 20 in the examples of the present application may further include a controller (not shown). The controller may control the voltages respectively applied to the electrodes of the first liquid crystal quarter wave plate 24 and the electrodes of the second liquid crystal quarter wave plate 27, so as to generate the images at two depths of field. For example, the controller may control the first liquid crystal quarter wave plate 24 to be always in a quarter wave plate state and the second liquid crystal quarter wave plate 27 to switch between a quarter wave plate state and an off state.

Table 1 below shows changes in the optical states of the first liquid crystal quarter wave plate 24 and the second liquid crystal quarter wave plate 27 when the images at two depths of field are implemented.

TABLE 1

| | | | | Effect on | 2D |
|---|---|---|---|---|---|
| Light | State of | State of | Description | depth of | transmitted |
| path | QWP2 | QWP1 | of light path | field | image |
| First | Off | Quarter | Focal | D1 | Image 1 |
| light | | wave plate | distance f1 | | |
| path | | | | | |
| Second | Quarter | Quarter | Pancake | D2 | Image 2 |
| light | wave plate | wave plate | light path, | | |
| path | | | focal | | |
| | | | distance f2 | | |

where f1 > f2, and D1 < D2.

Two light paths of the display system 20 in the examples of the present application will be described in detail below in combination with Table 1 and with reference to FIG. 1 and FIG. 2.

As shown in FIG. 1, when the first liquid crystal quarter wave plate 24 is in a quarter wave plate state and the second liquid crystal quarter wave plate 27 is in an off state, light emitted from the display module 21 passes through the linear polarizer 23 to generate linearly polarized light. For example, light output from the linear polarizer 23 is 0° and a light extraction efficiency is 1. 0° linearly polarized light passes through the first liquid crystal quarter wave plate 24 placed, for example, at a 45° optical axis and becomes right-handed circularly polarized light since at this time the first liquid crystal quarter wave plate 24 is in a quarter wave plate state. Next the right-handed circularly polarized light sequentially passes through the first lens 25 and the half mirror 26, and a polarization state remains unchanged. But since the half mirror 26 transmits half of any polarized light and reflects half of the any polarized light, at this time, the light extraction efficiency becomes ½. Then the polarized light passes through the second liquid crystal quarter wave plate 27 that is in an off state and the polarization state remains unchanged, and finally, the polarized light reaches the reflective polarizer 28 in the form of the right-handed circularly polarized light. A transmission axis of the reflective polarizer 28 is 90°. At this time, 90° linearly polarized light is directly emitted, and the overall light extraction efficiency is ¼. The display system 20 has a direct-through first light path, and at this time, the display system 20 has a first focal distance f1 and generates an image at a first depth of field D1.

As shown in FIG. 2, when both the first liquid crystal quarter wave plate 24 and the second liquid crystal quarter wave plate 27 are in a quarter wave plate state, light emitted from the display module 21 passes through the linear polarizer 23 to generate linearly polarized light. For example, light output from the linear polarizer 23 is 0° and a light extraction efficiency is 1. 0° linearly polarized light passes through the first liquid crystal quarter wave plate 24 placed, for example, at a 45° optical axis. At this time, since the first liquid crystal quarter wave plate 24 is in a quarter wave plate state, the linearly polarized light becomes right-handed circularly polarized light. Next the right-handed circularly polarized light sequentially passes through the first lens 25 and the half mirror 26, and a polarization state remains unchanged. But since the half mirror 26 transmits half of any polarized light and reflects half of the any polarized light, at this time, the light extraction efficiency becomes ½, and the polarized light reaches the second liquid crystal quarter wave plate 27 that is in a quarter wave plate state in the form of the right-handed circularly polarized light. Since the optical axis of the second liquid crystal quarter wave plate 27 is orthogonal to the optical axis of the first liquid crystal quarter wave plate 24, the optical axis of the second liquid crystal quarter wave plate 27 is −45°. At this time, the right-handed circularly polarized light, after passing through the second liquid crystal quarter wave plate 27, turns again to the 0° linearly polarized light, and the 0° linearly polarized light reaches the reflective polarizer 28. Since the reflective polarizer 28 transmits 90° linearly polarized light and reflects 0° linearly polarized light, the 0° linearly polarized light, after entering the reflective polarizer 28, is reflected back. The polarized light, when passing through the second liquid crystal quarter wave plate 27 that is in a quarter wave plate state for the second time, becomes right-handed circularly polarized light again. The right-handed circularly polarized light, after passing through the half mirror 26 again, is changed into left-handed circularly polarized light, and at this time, the light extraction efficiency is changed to ¼. The left-handed circularly polarized light, after passing through the second liquid crystal quarter wave plate 27 that is in a quarter wave plate state for the third time, is changed into 90° linearly polarized light. Since the reflective polarizer 28 transmits 90° linearly polarized light and reflects 0° linearly polarized light, the 90° linearly polarized light may thus be output from the reflective polarizer 28, and at this time, the overall light extraction efficiency is ¼. The polarized light, after being pancaked once between the half mirror 26 and the reflective polarizer 28, is emitted from the reflective polarizer 28. The display system 20 has a pancake second light path, and at this time, the display system 20 has a second focal distance f2 and generates an image at a second depth of field D2.

As shown in FIG. 1 and FIG. 2, the second focal distance f2 of the display system 20 is less than the first focal distance f1 of the display system 20, and the second depth of field D2 is greater than the first depth of field D1.

When a refresh frequency of display of the display system 20 is N Hz (hertz) (N=45, 60, 72, 90 or higher), the display module 21 is to respectively convey image sources for a near field image and a far field image at a frequency of 2N, and meanwhile, the second liquid crystal quarter wave plate 27 switches between the off state and the quarter wave plate state at a refresh frequency of 2N. That is, within ½N s (second), the display module 21 provides the near field image, and the second liquid crystal quarter wave plate 27 is powered on to reach the off state; after ½N s, the display module 21 switches to the far field image, and meanwhile, the second liquid crystal quarter wave plate 27 switches to the quarter wave plate state. This sequence repeats continuously, so as to realize a monocular multi-depth-of-field VR display.

In the display system 20 according to the examples of the present application, by using the switchable liquid crystal wave plates and applying the voltages to the liquid crystal wave plates, the liquid crystal wave plates can switch between two optical states at a relatively high frequency and cooperate with other optical devices, so that two different focal distances and virtual image distances can be generated. In collaboration with 2D image sources of the display module 21 displaying different information at two moments, in a manner of time division multiplexing, two images with different virtual image distances can be seen, so as to realize a monocular multi-depth-of-field VR display.

In some examples, the reflective polarizer 28 is a wire grid polarizer (WGP), and the wire grid polarizer may be integrated on the second liquid crystal quarter wave plate 27. The wire grid polarizer is a wire grid metal design, and while transmitting light in a polarization state, reflects light in another polarization state.

The reflective polarizer 28 in the display system 20 according to the examples of the present application is integrated on the second liquid crystal quarter wave plate 27 by way of WGP, so that a resource utilization rate of the overall system is further improved, and there is no attachment problem.

In some examples, the half mirror 26 is a half reflection half transmission film coated on the second liquid crystal quarter wave plate 27.

In some examples, the display system 20 may further include a second lens 29, and the second lens 29 is located in a light path from the reflective polarizer 28 to the eye, so that the second lens 29 may be used to change a focal distance of the display system 20 to send a generated image to a specified depth-of-field position, and imaging quality can be changed. The display system 20 shown in FIG. 1 and FIG. 2 includes one second lens 29. However, the display system 20 in the examples of the present application is not limited to including only one second lens 29. In other examples, the display system 20 in the examples of the present application may not include the second lens, or include more second lenses.

In the first example described above, in the display system 20, by switching between two optical states of the second liquid crystal quarter wave plate 27, the images at two depths of field are implemented. In order to make an effect of image stereo fusion finer, a display system in a second example is further provided below.

### Second Example

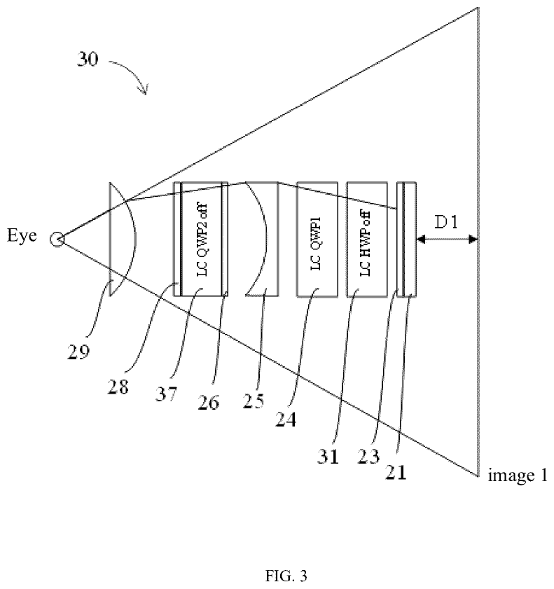

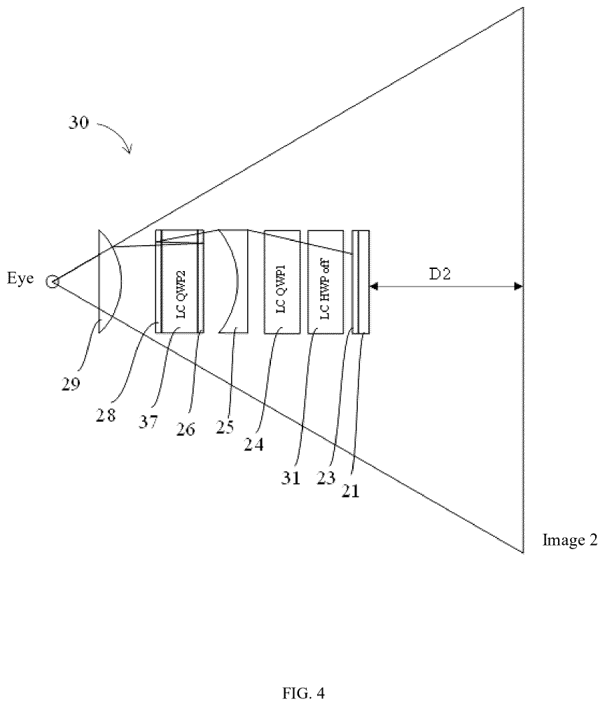

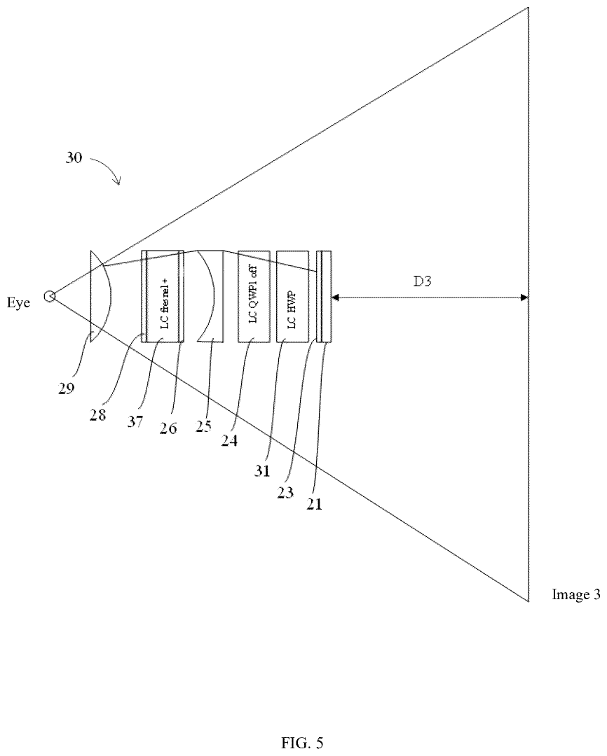

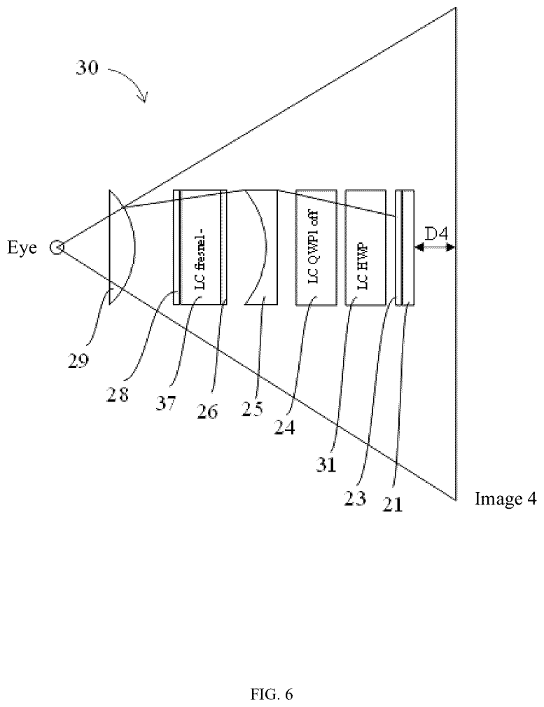

FIG. 3 is a schematic diagram showing a light path of a display system 30 having a first light path according to a second example of the present application. FIG. 4 is a schematic diagram showing a light path of the display system 30 having a second light path according to the second example of the present application. FIG. 5 is a schematic diagram showing a light path of the display system 30 having a third light path according to the second example of the present application. FIG. 6 is a schematic diagram showing a light path of the display system 30 having a fourth light path according to the second example of the present application. Referring to FIG. 3 to FIG. 6, different from the display system 20 in the first example, the display system 30 according to the second example further includes a switchable half wave plate. In some examples, the switchable half wave plate includes a liquid crystal half wave plate 31. Of course, the switchable half wave plate in the examples of the present application is not limited to using the form of a liquid crystal wave plate. In other examples, the switchable half wave plate according to the examples of the present application may be implemented in other forms that can change an optical state of a wave plate. An example in which the switchable half wave plate is the liquid crystal half wave plate 31 will be taken below for illustrative description.

The liquid crystal half wave plate 31 is located in a light path between the display module 21 and the first liquid crystal quarter wave plate 24. An angle between an optical axis of the liquid crystal half wave plate 31 and the optical axis of the linear polarizer 23 is 22.5 degrees.

Similarly, the liquid crystal half wave plate 31 has electrodes and a liquid crystal layer 313 located between the electrodes. The liquid crystal half wave plate 31 may have different optical states under the driving of different voltages.

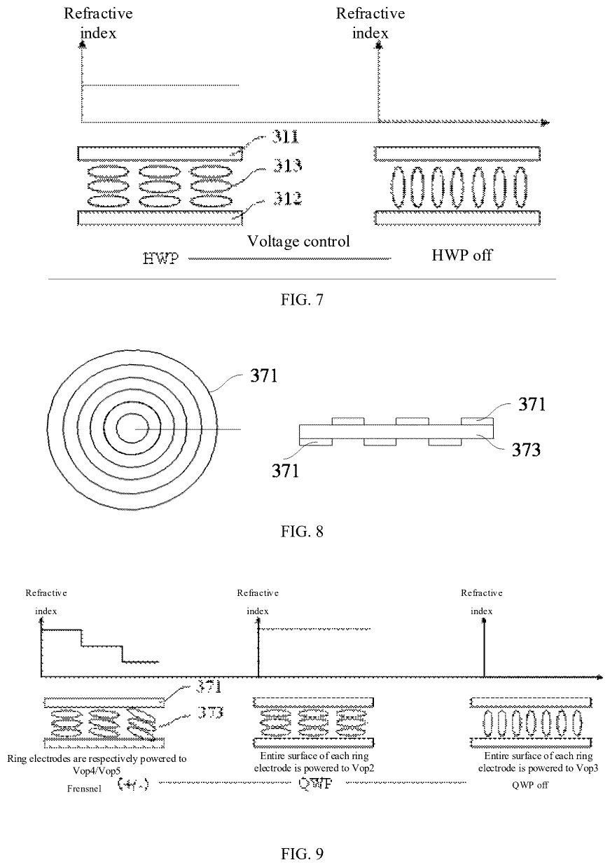

FIG. 7 is a schematic diagram showing light paths of a liquid crystal half wave plate 31 before and after being powered on according to an example of the present application. As shown in FIG. 7, in some examples, the liquid crystal half wave plate 31 (HWP) may include, for example, a planar first electrode 311, a planar second electrode 312, and a liquid crystal layer 313 located between the planar first electrode 311 and the planar second electrode 312. Through voltages applied to the planar first electrode 311 and the planar second electrode 312, an arrangement state of liquid crystal molecules in the liquid crystal layer 313 can be changed, so that the liquid crystal half wave plate 31 can have different optical states.

The liquid crystal half wave plate 31 may have a second optical state and a fifth optical state. The second optical state includes an off state, and the fifth optical state may include, for example, a ½ wave plate state.

Referring to FIG. 7, when no voltage is applied to the electrodes of the liquid crystal half wave plate 31, the liquid crystal molecules in the liquid crystal layer 313 of the liquid crystal half wave plate 31 remain an initial horizontal arrangement manner, and the liquid crystal half wave plate 31 is in an initial half wave plate state. At this time, a refractive index of the liquid crystal half wave plate 31 is relatively higher. When a voltage is applied to the electrodes of the liquid crystal half wave plate 31, the liquid crystal molecules in the liquid crystal layer 313 of the liquid crystal half wave plate 31 are vertically arranged, and the liquid crystal half wave plate 31 is in an off state. At this time, the refractive index of the liquid crystal half wave plate 31 is relatively lower.

Still different from the display system 20 in the first example, as shown in FIG. 8, in the display system 30 in the second example, electrodes of a second liquid crystal quarter wave plate 37 include a plurality of ring electrodes 371 arranged in a staggered manner, and a liquid crystal layer 373 is located between the plurality of ring electrodes 371. As shown in FIG. 8, staggered manner means that the ring electrodes are arranged in an ascending way from a center of the rings so that for any two adjacent ring electrodes, the outer circle of the smaller ring electrode and the inner circle of the larger ring electrode are of the same radius but are arranged on separate sides of the liquid crystal layer. Through different voltages applied to the ring electrodes 371, an arrangement state of liquid crystal molecules in the liquid crystal layer 373 can be changed, so that the second liquid crystal quarter wave plate 37 can have a plurality of different optical states.

In an example, in addition to the first optical state and the second optical state mentioned in the first example, the second liquid crystal quarter wave plate 37 may further have a third optical state and a fourth optical state. The third optical state may include, for example, a Fresnel convex lens state, and the fourth optical state may include, for example, a Fresnel concave lens state.

FIG. 9 is a schematic diagram showing light paths of the second liquid crystal quarter wave plate 37 applied with different voltages according to an example of the present application. As shown in FIG. 9, when a second voltage Vop2 is applied to an entire surface of each ring electrode 371 of the second liquid crystal quarter wave plate 37, the second liquid crystal quarter wave plate 37 is in a quarter wave plate state, and at this time, the second liquid crystal quarter wave plate 37 has a relatively larger refractive index. When a third voltage Vop3 is applied to the entire surface of each ring electrode 371 of the second liquid crystal quarter wave plate 37, the second liquid crystal quarter wave plate 37 is in an off state, and at this time, the second liquid crystal quarter wave plate 37 has a relatively lower refractive index. When a fourth voltage Vop4 is applied to the ring electrodes 371 of the second liquid crystal quarter wave plate 37, the second liquid crystal quarter wave plate 37 is in a Fresnel convex lens state. When a fifth voltage Vop5 is applied to the ring electrodes 371 of the second liquid crystal quarter wave plate 37, the second liquid crystal quarter wave plate 37 is in a Fresnel concave lens state.

In an example, the applied second voltage Vop2 is greater than the third voltage Vop3, the applied fourth voltage Vop4 and fifth voltage Vop5 are respectively between the second voltage Vop2 and the third voltage Vop3, and the fourth voltage Vop4 and the fifth voltage Vop5 are gradient voltages. For example, when the second liquid crystal quarter wave plate 37 is in a Fresnel convex lens state, a voltage applied to a ring electrode 371 in an outermost ring, which is equivalent to a very edge region of a convex lens, is highest, and a refractive index is lowest; a voltage applied to a ring electrode 371 in a central ring, which is equivalent to a middle bulging portion of a convex lens, is lowest, and a refractive index is highest. When the second liquid crystal quarter wave plate 37 is in a Fresnel concave lens state, opposite voltages are applied.

In the second example, a controller (not shown) in the display system 30 may control the voltages respectively applied to the first liquid crystal quarter wave plate 24, the second liquid crystal quarter wave plate 37, and the liquid crystal half wave plate 31, so as to generate images at four depths of field. For example, the controller may control the first liquid crystal quarter wave plate 24 to switch between a quarter wave plate state and an off state, the second liquid crystal quarter wave plate 37 to switch among a quarter wave plate state, an off state, a Fresnel convex lens state, and a Fresnel concave lens state, and the liquid crystal half wave plate 31 to switch between a half wave plate state and an off state.

Table 2 below shows changes in the optical states of the liquid crystal half wave plate 31, the first liquid crystal quarter wave plate 24 and the second liquid crystal quarter wave plate 37 when the images at four depths of field are implemented.

TABLE 2

| | | | | | Effect on | 2D |
|---|---|---|---|---|---|---|
| Light | State of | State of | State of | Description | depth of | transmitted |
| path | QWP2 | QWP1 | HWP | of light path | field | image |
| First | Off | Quarter | Off | 1 concave lens | D1 | Image 1 |
| light path | | wave plate | | 1 convex lens, | | |
| | | | | focal distance f1 | | |
| Second | Quarter | Quarter | Off | Pancake light path, | D2 | Image 2 |
| light path | wave plate | wave plate | | focal distance f2 | | |
| Third | Fresnel | Off | Half wave | 1 concave lens | D3 | Image 3 |
| light path | convex lens | | plate | 2 convex lenses, | | |
| | (+) | | | focal distance f3 | | |
| Fourth | Fresnel | Off | Half wave | 2 concave lenses | D4 | Image 4 |
| light path | concave lens | | plate | 1 convex lens, | | |
| | (−) | | | focal distance f4 | | |

where f4 > f1 > f2 > f3, and D4 < D1 < D2 < D3.

Four light paths of the display system 30 in the examples of the present application will be described in detail below in combination with Table 2 and with reference to FIG. 3 to FIG. 6.

As shown in FIG. 3, when the liquid crystal half wave plate 31 is in an off state, the first liquid crystal quarter wave plate 24 is in a quarter wave plate state, and the second liquid crystal quarter wave plate 37 is in an off state, light emitted from the display module 21 passes through the linear polarizer 23 to generate linearly polarized light. For example, light output from the linear polarizer 23 is 0° and a light extraction efficiency is 1. 0° linearly polarized light passes through the liquid crystal half wave plate 31 that is in an off state, without changing a polarization state. 0° linearly polarized light directly enters the first liquid crystal quarter wave plate 24, and after passing through the first liquid crystal quarter wave plate 24 that is in a quarter wave plate state, becomes right-handed circularly polarized light. Next the right-handed circularly polarized light sequentially passes through the first lens 25 and the half mirror 26, and the polarization state remains unchanged. But since the half mirror 26 transmits half of any polarized light and reflects half of the any polarized light, at this time, the light extraction efficiency becomes ½, then the polarized light passes through the second liquid crystal quarter wave plate 37 that is in an off state, without changing the polarization state. Finally, the polarized light reaches the reflective polarizer 28 in the form of the right-handed circularly polarized light. A transmission axis of the reflective polarizer 28 is 90°. At this time, 90° linearly polarized light is directly emitted, and the overall light extraction efficiency is ¼. The display system 30 has a direct-through first light path, and at this time, the display system 30 has a first focal distance f1 and generates an image at a first depth of field D1.

As shown in FIG. 4, when the liquid crystal half wave plate 31 is in an off state, and both the first liquid crystal quarter wave plate 24 and the second liquid crystal quarter wave plate 37 are in a quarter wave plate state, light emitted from the display module 21 passes through the linear polarizer 23 to generate linearly polarized light. For example, light output from the linear polarizer 23 is 0° and a light extraction efficiency is 1. 0° linearly polarized light passes through the liquid crystal half wave plate 31 that is in an off state, without changing a polarization state. 0° linearly polarized light directly enters the first liquid crystal quarter wave plate 24. At this time, since the first liquid crystal quarter wave plate 24 is in a quarter wave plate state, the linearly polarized light becomes right-handed circularly polarized light. Next the right-handed circularly polarized light sequentially passes through the first lens 25 and the half mirror 26, and the polarization state remains unchanged. But since the half mirror 26 transmits half of any polarized light and reflects half of the any polarized light, at this time, the light extraction efficiency becomes ½. The polarized light reaches the second liquid crystal quarter wave plate 37 that is in a quarter wave plate state in the form of the right-handed circularly polarized light. At this time, the right-handed circularly polarized light, after passing through the second liquid crystal quarter wave plate 37, turns again to the 0° linearly polarized light, and the 0° linearly polarized light reaches the reflective polarizer 28. Since the reflective polarizer 28 transmits 90° linearly polarized light and reflects 0° linearly polarized light, the 0° linearly polarized light, after entering the reflective polarizer 28, is reflected back. The polarized light, when passing through the second liquid crystal quarter wave plate 37 that is in a quarter wave plate state for the second time, becomes again right-handed circularly polarized light. The right-handed circularly polarized light, after passing through the half mirror again, is changed into left-handed circularly polarized light, and at this time, the light extraction efficiency is changed into ¼. The left-handed circularly polarized light, after passing through the second liquid crystal quarter wave plate 37 that is in a quarter wave plate state for the third time, is changed into 90° linearly polarized light. Since the reflective polarizer 28 transmits 90° linearly polarized light and reflects 0° linearly polarized light, the 90° linearly polarized light may thus be output from the reflective polarizer 28, and at this time, the overall light extraction efficiency is ¼. The polarized light, after being pancaked once between the half mirror 26 and the reflective polarizer 28, is emitted from the reflective polarizer 28. The display system 20 has a pancake second light path, and at this time, the display system 20 has a second focal distance f2 and generates an image at a second depth of field D2. The second focal distance f2 is less than the first focal distance f1, and the second depth of field D2 is greater than the first depth of field D1.

As shown in FIG. 5, when the liquid crystal half wave plate 31 is in a half wave plate state, the first liquid crystal quarter wave plate 24 is in an off state, and the second liquid crystal quarter wave plate 37 is in a Fresnel convex lens state, since the liquid crystal half wave plate 31 is in a half wave plate state, for example, 0° linearly polarized light passing through the linear polarizer 23 is modulated into 90° linearly polarized light (which is consistent with the optical axis of the first liquid crystal quarter wave plate 24), then sequentially passes through the first liquid crystal quarter wave plate 24 that is in an off state, the first lens 25 and the half mirror 26 with a polarization state unchanged and reaches the second liquid crystal quarter wave plate 37. At this time, since the second liquid crystal quarter wave plate 37 is in a Fresnel convex lens state, after the 90° linearly polarized light passes through the second liquid crystal quarter wave plate 37, the polarization state is not changed, and finally is directly emitted from the reflective polarizer 28 (which transmits 90° linearly polarized light and reflects 0° linearly polarized light). The display system 30 has another direct-through third light path, and at this time, the display system 30 has a third focal distance f3 and generates an image at a third depth of field D3. The third focal distance f3 is less than the second focal distance f2, and the third depth of field D3 is greater than the second depth of field D2.

As shown in FIG. 6, when the liquid crystal half wave plate 31 is in a half wave plate state, the first liquid crystal quarter wave plate 24 is in an off state, and the second liquid crystal quarter wave plate 37 is in a Fresnel concave lens state, since the liquid crystal half wave plate 31 is in a half wave plate state, for example, 0° linearly polarized light passing through the linear polarizer 23 is modulated into 90° linearly polarized light (which is consistent with the optical axis of the first liquid crystal quarter wave plate 24), then sequentially passes through the first liquid crystal quarter wave plate 24 that is in an off state, the first lens 25 and the half mirror 26, and a polarization state remains unchanged. The 90° linearly polarized light reaches the second liquid crystal quarter wave plate 37. At this time, since the second liquid crystal quarter wave plate 37 is in a Fresnel concave lens state, after the 90° linearly polarized light passes through the second liquid crystal quarter wave plate 37, the polarization state is not changed, and finally the polarized light is directly emitted from the reflective polarizer 28. The display system 30 has another direct-through fourth light path, and at this time, the display system 30 has a fourth focal distance f4 and generates an image at a fourth depth of field D4. The fourth focal distance f4 is greater than the first focal distance f1, and the fourth depth of field D4 is less than the first depth of field D1.

The images at fourth depths of field may be switched at a high frequency, allowing for fusion into a stereo effect out of persistence of vision of human eye, so as to realize a finer monocular multi-depth-of-field VR display of the images.

Embodiments of the present application further provide a display device. The display device may include the display system described in the above examples.

In an example, the display device may be a virtual reality display device. In another example, the display device may be an augmented reality display device.

The display device according to the examples of the present application has beneficial technical effects substantially similar to those of the display system described above, which will not be repeated here.

The display system and the display device provided in the examples of the present application have been introduced in detail above. Specific examples are applied herein to describe the display system and the display device in the examples of the present application. The illustration of the above examples is intended only to help understand the core idea of the present application, but is not intended to limit the present application. It should be noted that, for those skilled in the art, several improvements and modifications may be made to the present application without departing from the spirit and principle of the present application, and these improvements and modifications should fall within the protection scope of the appended claims of the present application.

1. A display system, comprising:
a display module configured to emit light, wherein a linear polarizer is attached to the display module and configured to generate linearly polarized light; and
in a light path starting from the display module, the display system further comprises a first switchable quarter wave plate, a first lens, a half mirror, a second switchable quarter wave plate, and a reflective polarizer,
wherein both the first quarter wave plate and the second quarter wave plate have electrodes; the first quarter wave plate is driven at a first voltage and the second quarter wave plate is driven at a second voltage, so that the display system generates an image at a first depth of field; the first quarter wave plate is driven at the first voltage and the second quarter wave plate is driven at a third voltage, so that the display system generates an image at a second depth of field, wherein the first depth of field is different from the second depth of field.

2. The display system according to claim 1, wherein the reflective polarizer is a wire grid polarizer integrated on the second quarter wave plate.

3. The display system according to claim 1, further comprising: one or more second lenses located in a light path from the reflective polarizer and away from the display module.

4. The display system according to claim 1, wherein an optical axis of the first quarter wave plate is orthogonal to an optical axis of the second quarter wave plate, and an optical axis of the reflective polarizer is orthogonal to an optical axis of the linear polarizer.

5. The display system according to claim 1, wherein the first quarter wave plate has a first optical state, and the second quarter wave plate has the first optical state and a second optical state, wherein, when the first quarter wave plate is in the first optical state and the second quarter wave plate is in the second optical state, the display system has a first light path and a first focal distance, and generates the image at the first depth of field; when both the first quarter wave plate and the second quarter wave plate are in the first optical state, the display system has a second light path and a second focal distance, and generates the image at the second depth of field, wherein the second focal distance is less than the first focal distance, and the second depth of field is greater than the first depth of field.

6. The display system according to claim 5, wherein the first optical state comprises a quarter wave plate state, and the second optical state comprises an off state.

7. The display system according to claim 5, further comprising: a controller configured to control voltages applied to the electrodes of the first quarter wave plate and the electrodes of the second quarter wave plate, so as to generate images at two depths of field.

8. The display system according to claim 5, further comprising: a switchable half wave plate located in a light path between the display module and the first quarter wave plate, wherein the half wave plate has electrodes, and the half wave plate has different optical states under driving of different voltages.

9. The display system according to claim 8, wherein the half wave plate has the second optical state, and, when the display system has the first light path or the second light path, the half wave plate is in the second optical state.

10. The display system according to claim 9, wherein the first quarter wave plate further has the second optical state, the second quarter wave plate further has a third optical state, and the half wave plate further has a fifth optical state,
wherein, when the half wave plate is in the fifth optical state, the first quarter wave plate is in the second optical state, and the second quarter wave plate is in the third optical state, the display system has a third light path and a third focal distance, and generates an image at a third depth of field, wherein the third focal distance is less than the second focal distance, and the third depth of field is greater than the second depth of field.

11. The display system according to claim 10, wherein the second quarter wave plate further has a fourth optical state, and, when the half wave plate is in the fifth optical state, the first quarter wave plate is in the second optical state, and the second quarter wave plate is in the fourth optical state, the display system has a fourth light path and a fourth focal distance, and generates an image at a fourth depth of field, wherein the fourth focal distance is greater than the first focal distance, and the fourth depth of field is less than the first depth of field.

12. The display system according to claim 11, wherein the electrodes of the second quarter wave plate comprise a plurality of ring electrodes arranged in a staggered manner.

13. The display system according to claim 12, wherein,
when the second voltage is applied to an entire surface of each of the ring electrodes of the second quarter wave plate, the second quarter wave plate is in the first optical state;
when the third voltage is applied to the entire surface of each of the ring electrodes of the second quarter wave plate, the second quarter wave plate is in the second optical state;
when a fourth voltage or a fifth voltage is applied to the ring electrodes of the second quarter wave plate, the second quarter wave plate is in the third optical state or the fourth optical state.

14. The display system according to claim 13, wherein the fourth voltage and the fifth voltage are respectively between the second voltage and the third voltage, and the fourth voltage and the fifth voltage are gradient voltages.

15. The display system according to claim 11, wherein the first optical state comprises a quarter wave plate state, the second optical state comprises an off state, the third optical state comprises a Fresnel convex lens state, the fourth optical state comprises a Fresnel concave lens state, and the fifth optical state comprises a half wave plate state.

16. The display system according to claim 11, further comprising: a controller configured to control voltages applied to the electrodes of the first quarter wave plate, the electrodes of the second quarter wave plate, and the electrodes of the half wave plate, so as to generate images at four depths of field.

17. The display system according to claim 8, wherein the first quarter wave plate comprises a first liquid crystal quarter wave plate; and/or the second quarter wave plate comprises a second liquid crystal quarter wave plate; and/or the half wave plate comprises a liquid crystal half wave plate.

18. A display device, comprising: the display system according to claim 1.

19. The display device according to claim 18, wherein the first quarter wave plate has a first optical state, and the second quarter wave plate has the first optical state and a second optical state, wherein, when the first quarter wave plate is in the first optical state and the second quarter wave plate is in the second optical state, the display system has a first light path and a first focal distance, and generates the image at the first depth of field; when both the first quarter wave plate and the second quarter wave plate are in the first optical state, the display system has a second light path and a second focal distance, and generates the image at the second depth of field, wherein the second focal distance is less than the first focal distance, and the second depth of field is greater than the first depth of field.

20. The display device according to claim 19,
wherein the display system further comprises a switchable half wave plate located in a light path between the display module and the first quarter wave plate, wherein the half wave plate has electrodes, and the half wave plate has different optical states under driving of different voltages;
wherein the half wave plate has the second optical state, and, when the display system has the first light path or the second light path, the half wave plate is in the second optical state;
wherein the first quarter wave plate further has the second optical state, the second quarter wave plate further has a third optical state, and the half wave plate further has a fifth optical state;
wherein, when the half wave plate is in the fifth optical state, the first quarter wave plate is in the second optical state, and the second quarter wave plate is in the third optical state, the display system has a third light path and a third focal distance, and generates an image at a third depth of field, wherein the third focal distance is less than the second focal distance, and the third depth of field is greater than the second depth of field;
wherein the second quarter wave plate further has a fourth optical state, and, when the half wave plate is in the fifth optical state, the first quarter wave plate is in the second optical state, and the second quarter wave plate is in the fourth optical state, the display system has a fourth light path and a fourth focal distance, and generates an image at a fourth depth of field, wherein the fourth focal distance is greater than the first focal distance, and the fourth depth of field is less than the first depth of field.
